(19) United States
(12) Patent Application Publication
(10) Pub. No.: US 2009/0200405 A1
(43) Pub. Date: Aug. 13, 2009

(54) FUEL INJECTION VALVE

(75) Inventors: Kiyotaka Yoshimaru, Obu-city (JP); Moriyasu Gotoh, Toyohashi-city (JP); Shinkichi Obayashi, Toyokawa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/365,328

(22) Filed: Feb. 4, 2009

(30) Foreign Application Priority Data
Feb. 13, 2008 (JP) 2008-31865
Nov. 20, 2008 (JP) 2008-296395

(51) Int. Cl. F02M 51/06

(52) U.S. Cl. 239/585.1; 251/129.21

(57) ABSTRACT

A coil is provided radially outside a housing. Each of a stator and a moving core is formed from a magnetic material and substantially in a tubular shape. The stator and the moving core are located radially inside the housing and opposed to each other in an axial direction. The moving core is configured to move toward the stator when being drawn by magnetic attractive force caused between the moving core and the stator in response to energization of the coil. A valve element is movable together with the moving core in the axial direction and configured to open and close a nozzle hole for controlling fuel injection. The moving core and the valve element are separate components. The moving core has an inner periphery defining a through hole in which the valve element is slidable in the axial direction. The inner circumferential periphery has a surface-hardened layer.

### CROSS REFERENCE TO RELATED APPLICATIONS

This application is based on and incorporates herein by reference Japanese Patent Applications No. 2008-31865 filed on Feb. 13, 2008 and No. 2008-296395 filed on Nov. 20, 2008.

### FIELD OF THE INVENTION

The present invention relates to a fuel injection valve for an internal combustion engine.

### BACKGROUND OF THE INVENTION

Conventionally, a fuel injection valve of an internal combustion engine includes a valve element, which is electromagnetically actuated so as to inject fuel. Such a fuel injection valve includes a tubular housing, a coil, a tubular stator, a tubular moving core, and a valve element. The coil is located radially outside of the housing. The stator is located in the housing. The moving core is located in the housing and opposed to the stator in the axial direction. The moving core is drawn by the stator when magnetic attractive force is caused between the moving core and the stator in response to energization of the coil. The valve element and the moving core move in the axial direction to open and close the nozzle hole so as to control fuel injection.

In such a fuel injection valve, in general, the moving core is integrated with the valve element, which is biased by a spring so as to close the nozzle hole. The moving core and the stator therebetween generate magnetic attractive force in response to energization of the coil. The moving core and the valve element, which are integrated with each other, move toward the stator in opposition to the biasing force of the spring, and thereby opening the nozzle hole so as to inject fuel. The moving core and the valve element move away from the stator by being applied with the biasing force of the spring in response to de-energization of the coil, and thereby closing the nozzle hole so as to stop the fuel injection. In the present fuel injection valve, the integrated moving core and the valve element collide against the stator and rebound on the stator when the nozzle hole is opened. In particular, when energization period of the coil is short, the amount of injected fuel cannot be sufficiently reduced in proportion to the reduced energization period, and accordingly the amount of injected fuel is hard to be controlled. Thus, the minimum controllable fuel injection quantity cannot be sufficiently reduced.

For example, US2005/0269432A1 (JP-A-2006-17101) proposes a fuel injection valve including a moving core and a valve element, which are separate components. The moving core has an inner periphery defining a through hole in which the valve element is slidable in the axial direction. In the present structure, when force is caused by the collision between the moving core and the stator, the force is applied only to the moving core, and thereby rebound of the valve element can be reduced. However, in the present structure, in which the moving core and the valve element are separate components, the inner circumferential periphery of the through hole causes ablation due to sliding with the valve element. In particular, the moving core needs to be formed from a magnetic material to have sufficient magnetic property. That is, it is difficult to form the moving core from a hard material, and the moving core is apt to cause abrasion. In general, the inner circumferential periphery of the through hole of the moving core and the valve element therebetween have a small clearance such as a tens of micrometers of gap so as to maintain the performance of the fuel injection valve. Therefore. when the moving core causes ablation and the clearance changes due to the abrasion, the performance of the fuel injection valve cannot be maintained

### SUMMARY OF THE INVENTION

In view of the foregoing and other problems, it is an object of the present invention to produce a fuel injection valve having a moving core, which has high ablation resistance.

According to one aspect of the present invention, a fuel injection valve comprises a housing substantially in a tubular shape. The fuel injection valve further comprises a coil located radially outside the housing. The fuel injection valve further comprises a stator located radially inside the housing, the stator being formed from a magnetic material and substantially in a tubular shape. The fuel injection valve further comprises a moving core located radially inside the housing and opposed to the stator in an axial direction, the moving core being formed from a magnetic material and substantially in a tubular shape, the moving core being configured to move toward the stator when being drawn by magnetic attractive force caused between the moving core and the stator in response to energization of the coil. The fuel injection valve further comprises a valve element movable together with the moving core in the axial direction and configured to open and close a nozzle hole for controlling fuel injection. The moving core has an inner periphery defining a through hole in which the valve element is slidable in the axial direction. The inner periphery has a first surface-hardened layer.

According to another aspect of the present invention, a fuel injection valve comprises a housing substantially in a tubular shape. The fuel injection valve further comprises a coil located radially outside the housing. The fuel injection valve further comprises a stator located radially inside the housing, the stator being formed from a magnetic material and substantially in a tubular shape. The fuel injection valve further comprises a moving core located radially inside the housing and opposed to the stator in an axial direction, the moving core being formed from a magnetic material and substantially in a tubular shape, the moving core being configured to move toward the stator when being drawn by magnetic attractive force caused between the moving core and the stator in response to energization of the coil. The fuel injection valve further comprises a valve element movable together with the moving core in the axial direction and configured to open and close a nozzle hole for controlling fuel injection. The moving core has an inner periphery defining a through hole in which the valve element is slidable in the axial direction. The inner periphery of the through hole and an outer periphery of the valve element therebetween define a fuel accumulator portion. The fuel accumulator portion is a recess of at least one of the inner periphery and the outer periphery.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing an injector according to a first embodiment;

FIG. 2 is a sectional view showing a moving core having a surface- hardened layer according to the first embodiment;

FIG. 3 is a sectional view showing the moving core having another surface-hardened layer according to a second embodiment;

FIG. 4 is a sectional view showing the moving core having another surface-hardened layer according to the second embodiment;

FIG. 5 is a sectional view showing the moving core having a fuel accumulator portion according to a third embodiment;

FIG. 6 is a sectional view showing a needle having the fuel accumulator portion according to the third embodiment;

FIG. 7 is a sectional view showing the moving core having both the surface-hardened layer and the fuel accumulator portion according to the third embodiment; and

FIG. 8 is a sectional view showing the moving core having another surface-hardened layer according to a fourth embodiment.

### DETAILED DESCRIPTION OF PREFERRED EMBODIMENTS

### First Embodiment

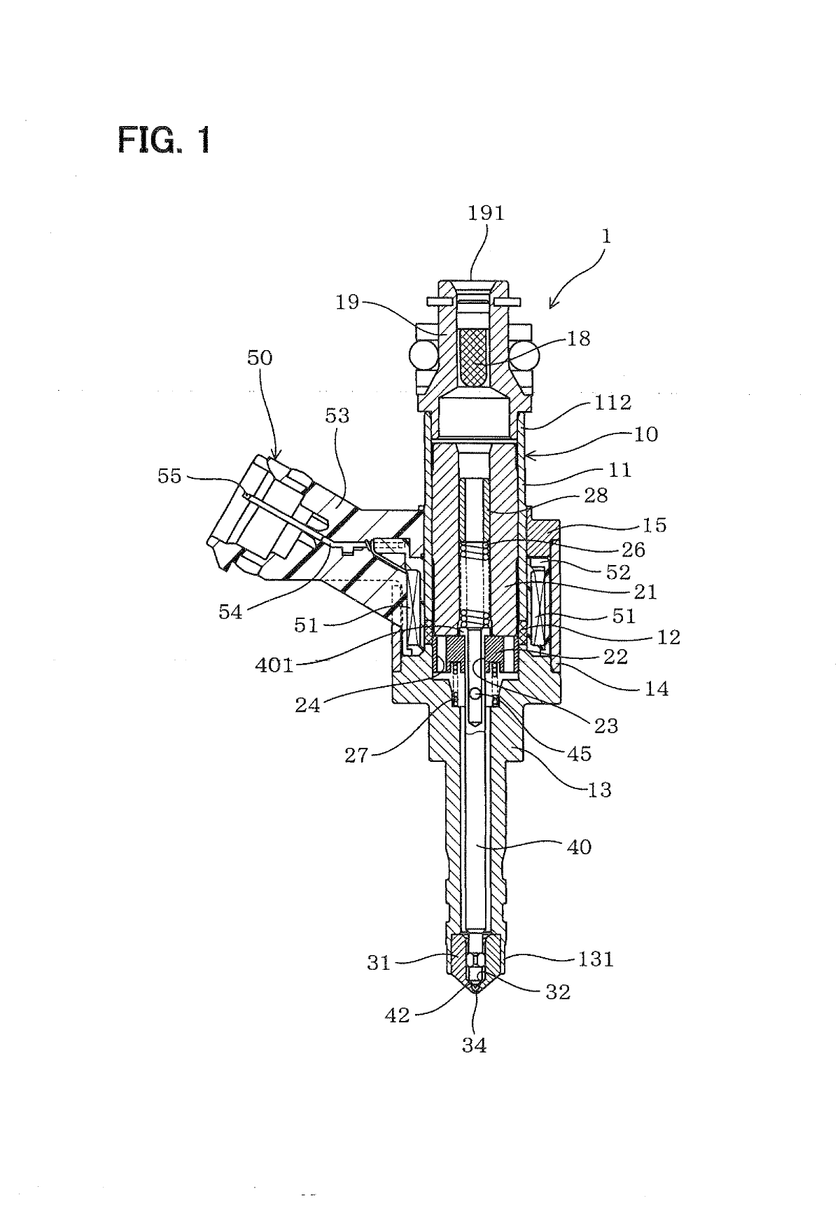

A fuel injection valve (injector) according to the present embodiment will be described with reference to drawings In the present embodiment, an injector 1 shown in FIG. 1 is applied to a direct-injection gasoline engine. The injector 1 is mounted to a cylinder head (engine head, not shown). The application of the injector 1 is not limited to the direct-injection gasoline engine, and the injector 1 may be applied to a premix gasoline engine or a diesel engine, for example. In the present embodiment, the injector 1 has a tip end side, to which nozzle holes 34 are provided, and a rear end side at the opposite side of the tip end side.

The injector 1 includes a housing 10, which is substantially in a tubular shape. The housing 10 includes a pipe 11, a nonmagnetic portion 12, and a holder 13, which are integrated by, for example, laser welding. The pipe 11 and the holder 13 are formed from a magnetic material such as electromagnetic stainless steel. The nonmagnetic portion 12 is formed from a nonmagnetic material. The pipe 11 has an inner circumferential periphery, which is press-fitted with a stator 21. The stator 21 is substantially in a tubular shape and formed from a magnetic material such as electromagnetic stainless steel. The stator 21 accommodates an adjusting pipe 28 and a first spring 26. The pipe 11 has a rear end 112, which is press-fitted with an external connector 19. The external connector 19 has a rear end defining a fuel inlet 191. The fuel inlet 191 is supplied with fuel by a fuel pump from a fuel tank (none shown). The fuel supplied to the fuel inlet 191 flows into the pipe 11 after passing through a filter member 18, which is provided in the external connector 19. The filter member 18 removes foreign matter contained in the fuel. The pipe 11 has a tip end, which is provided with the nonmagnetic portion 12. The nonmagnetic portion 12 has a tip end, which is provided with the holder 13. The nonmagnetic portion 12, which is formed from a nonmagnetic material, restricts short circuit between the pipe 11 and the holder 13 each being formed from a magnetic material.

The holder 13 has a tip end 131, which accommodates a valve body 31. The valve body 31 is substantially in a tubular shape, for example, and fixed to the tip end 131 of the holder 13 by press-fitting, welding, or the like. The valve body 31 has an inner wall surface, which is substantially in a conical shape and reduces in inner diameter toward the tip end thereof. The inner wall surface of the valve body 31 defines a valve seat 32. The nozzle holes 34 are provided in the tip end of the valve body 31. The nozzle holes 34 communicate the inside of the valve body 31 with the outside of the valve body 31 All the nozzle holes 34 may be integrated into a single hole. Alternatively, the nozzle holes 34 may include multiple hoes. The holder 13 accommodates a moving core 22. The moving core 22 is substantially in a tubular shape and formed from a magnetic material such as electromagnetic stainless steel. The moving core 22 is opposed to the stator 21 in the axial direction. The moving core 22 is moved by magnetic attractive force, which is caused between the moving core 22 and the stator 21 in response to electricity supply to a coil 51, and drawn toward the stator 21. The moving core 22 is movable in the axial direction inside the holder 13.

The moving core 22 has an inner circumferential periphery defining a through hole 23, which extends substantially in the axial direction. The moving core 22 further has multiple communication holes 24 each extending substantially in the axial direction. The multiple communication holes 24 are located outside the through hole 23. The communication holes 24 are configured to therethrough flow fuel so as to smoothly open and close a needle 40. The holder 13 accommodates the needle (valve element) 40. The needle 40 is located in the through hole 23 of the moving core 22, and the needle 40 extends through the through hole 23. The needle 40 is a separate component from the moving core 22 and slidable in the through hole 23 in the moving core 22. Namely, according to the present embodiment, the moving core 22 and the needle 40 are two components, which are 5 separate from each other. The moving core 22 and the needle 40 are not fixed to each other and configured to move in the axial direction relative to each other. The needle 40 is substantially coaxial with the valve body 31. The needle 40 and the moving core 22 are integrally movable in the axial direction. The needle 40 has a tip end defining a seal portion 42. The seal portion 42 is configured to be seated on the valve seat 32 of the valve body 31. As described above, the moving core 22 and the needle 40 are two components, nevertheless need not be distant, i.e., spaced from each other. The needle 40 has a rear end, which is in contact with the first spring 26 as a biasing member. The first spring 26 has one end, which is in contact with the rear end of the needle 40. The first spring 26 has the other end, which is in contact with the adjusting pipe 28. The moving core 22 has a tip end, which is in contact with a second spring 27 as a biasing member. Each of the biasing members is not limited to the spring and may be a blade spring, a gas damper, a liquid damper, or the like. The adjusting pipe 28 is press-inserted into the inner circumferential periphery of the stator 21. The load exerted from the first spring 26 can be controlled by adjusting the press-fit margin of the adjusting pipe 28. The first spring 26 is resilient and extendable in the axial direction, In the present structure, the needle 40 and the moving core 22 are integrally biased from the first spring 26 such that the seal portion 42 is seated to the valve seat 32. Simultaneously, the moving core 22 is biased from the second spring 27 such that the rear end of the moving core 22 makes contact with a needle stopper 401 of the needle 40.

A coil assembly 50 is provided around the outer circumferential periphery of the pipe 11. The coil assembly 50 is integrally formed of the coil 51, a mold element 52, and an electrical connector 53. The coil 51 is covered with the mold element 52, which is formed from resin. The coil 51 is substantially in a tubular shape and has an outer circumferential periphery and an inner circumferential periphery both being covered with the mold element 52. The coil 51 surrounds substantially entirely the outer circumferential periphery of the pipe 11 in the circumferential direction. The mold element 52 and the electrical connector 53 are integrally formed from resin. The coil 51 is connected with a terminal 55 of the electrical connector 53 via a wiring member 54. A housing plate 14 is provided around the outer circumferential periphery of the coil 51. The housing plate 14 is substantially in a tubular shape. The housing plate 14 and the pipe 11 therebetween support the coil 51 covered with the mold element 52. The coil 51 has the rear end, which is provided with a cover 15. The cover 15 surrounds the rear end of the coil 51. The housing plate 14 and the cover 15 are formed from a magnetic material such as electromagnetic stainless steel.

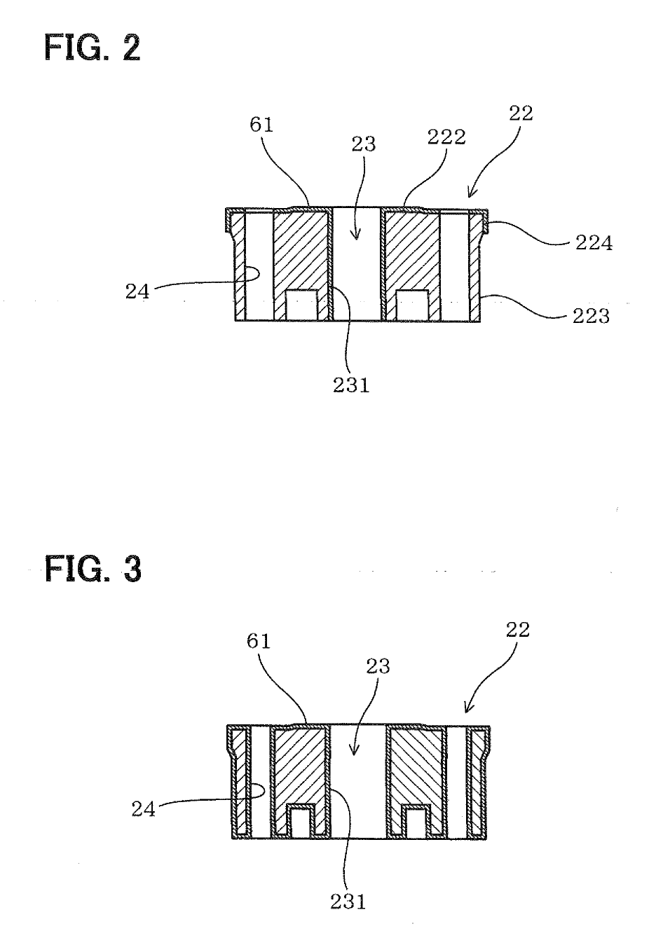

In the injector 1 according to the present embodiment, as shown in FIG. 2, the moving core 22 has an inner circumferential periphery 231 defining the through hole 23. The inner circumferential periphery 231 has a surface-hardened layer 61. In the present embodiment, the surface-hardened layer 61 is provided to a rear end surface 222 and an outer sliding surface 224 of the moving core 22, in addition to the inner circumferential periphery 231 of the moving core 22, which defines the through hole 23. The outer sliding surface 224 is a portion of an outer circumferential periphery 223. The moving core 22 is slidable with the inner circumferential periphery of the housing 10 via the outer sliding surface 224. The surface-hardened layer 61 is formed from a material harder than the magnetic material, such as electromagnetic stainless steel, of the moving core 22. The surface-hardened layer 61 is, for example, a hard chrome plating film (plated layer). The surface-hardened layer 61 is formed by, for example, electroplating. The surface-hardened layer 61 has the Vickers hardness of, for example, Hv800 when being formed by hard chrome plating. The surface-hardened layer 61 is greater than the moving core 22, which is formed from am electromagnetic stainless steel, in Vickers hardness. The surface-hardened layer 61 is, for example, 1 to 15 micrometers in thickness.

Next, an operation of the injector 1 will be described. When electricity is not supplied to the coil 51, the stator 21 and the moving core 22 do not generate magnetic attractive force therebetween. In the present condition, the moving core 22 is biased by the first spring 26 and moved away from the stator 21. Consequently, the seal portion 42 of the needle 40 is seated on the valve seat 32 to be in a closed state when the coil 51 is not supplied with electricity. Therefore, fuel is not injected from the nozzle holes 34. When the coil 51 is supplied with electricity, the coil 51 generates a magnetic field to cause magnetic flux through a magnetic circuit, which is constructed of the housing plate 14, the holder 13, the moving core 22, the stator 21, the pipe 11, and the cover 15. Thus, the stator 21 and the moving core 22, which are apart from each other, generate magnetic attractive force therebetween. When the magnetic attractive force, which is generated between the stator 21 and the moving core 22, becomes greater than the biasing force of the first spring 26, the moving core 22 and the needle 40 move toward the stator 21. Thereby, the moving core 22 makes contact with and collides against the stator 21. Consequently, the seal portion 42 of the needle 40 is lifted from the valve seat 32 to be in an opened state. Fuel flows into the fuel inlet 191 and passes through the filter member 18 and passages inside the pipe 11, the stator 21, the adjusting pipe 28, and the needle 40. Thus, the fuel flows out of the needle 40 through a fuel hole 45. The fuel flowing into the passage between the needle 40 and the holder 13 passes through the gap between the valve body 31 and the needle 40, which is lifted from the valve seat 32. Thus, the fuel is injected from the nozzle holes 34. When electricity supply to the coil 51 is terminated, the magnetic attractive force between the stator 21 and the moving core 22 substantially disappears. In the present operation, the moving core 22 and the needle 40 move away from the stator 21 by being exerted with the biasing force of the first spring 26. Thereby, the moving core 22 is apart from the stator 21 Consequently, the seal portion 42 of the needle 40 is again seated on the valve seat 32 to be in the closed state. Thus, fuel injection from the nozzle holes 34 is terminated.

Next, an operation effect of the injector 1 according to the present embodiment will be described. According to the present embodiment, the injector I includes the moving core 22 and the needle 40, which are separate components, i.e., individual components. The needle 40 is slidable in the through hole 23 and extends through the through hole 23. The inner periphery of the moving core 22 defines the through hole 23, which extends in the axial direction. Namely, the moving core 22 and the needle 40 are two components, which are separate from each other. The moving core 22 and the needle 40 are not fixed to each other and configured to move in the axial direction relative to each other. The inner circumferential periphery 231, along which the needle 40 is slidable, defines the through hole 23 in the moving core 22. The inner circumferential periphery 231 has the surface-hardened layer 61.

In the present structure, the needle 40 slides along the inner circumferential periphery 231 of the through hole 23 of the moving core 22. Even in the present structure, the surface-hardened layer 61 can restrict the inner circumferential periphery 231 from causing ablation. Thus, durability of the moving core 22 can be enhanced. Furthermore, change in the clearance between the moving core 22 and the needle 40 can be decreased by reducing abrasion in the moving core 22. Therefore, the performance of the injector 1 such as a characteristic of fuel injection can be maintained, and thereby reliability of the injector 1 can be enhanced. Further, according to the present embodiment, the surface-hardened layer 61 is formed from a material harder than the magnetic material, such as electromagnetic stainless steel, of the moving core 22. The surface-hardened layer 61 is, for example, the hard chrome plating film. The surface-hardened layer 61 has the Vickers hardness of, for example, Hv800, and the surface-hardened layer 61 is, for example, 1 to 15 micrometers in thickness. Therefore, the moving core 22 can be sufficiently restricted from causing ablation by being provided with the surface-hardened layer 61.

The surface-hardened layer 61 is preferably has the Vickers hardness of Hv400 or greater. When the Vickers hardness of the surface-hardened layer is less than Hv400, the moving core may cause abrasion. The surface-hardened layer 61 may be formed by electroless plating.

As described above, according to the present embodiment, abrasion of the moving core can be reduced, and thereby an injector (fuel injection valve) excellent in durability and reliability can be produced.

### Second Embodiment

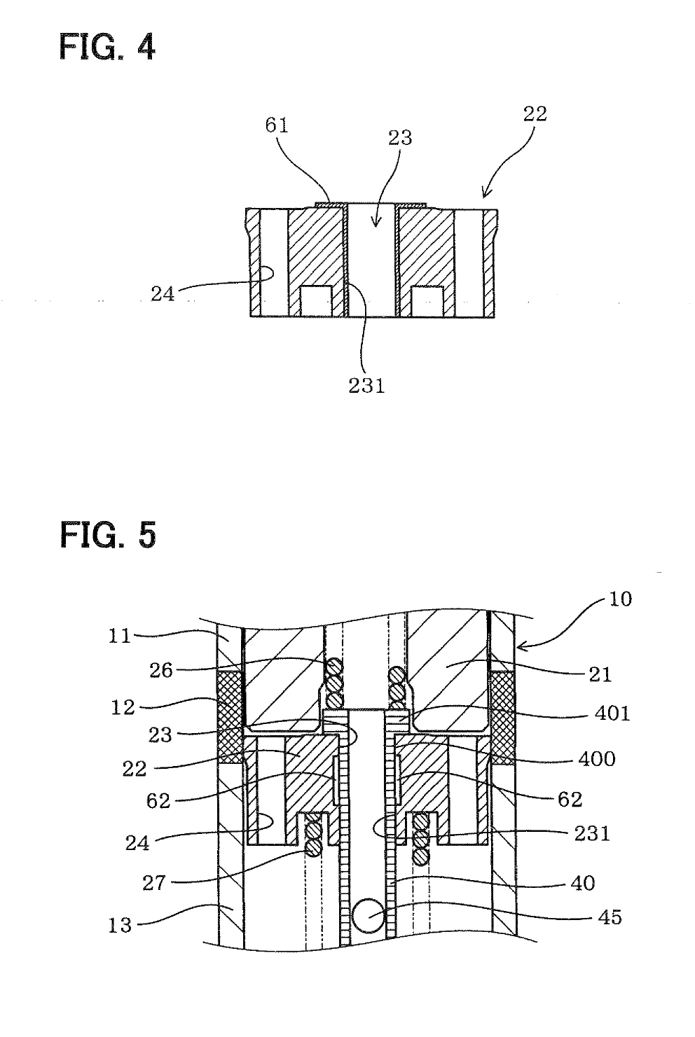

In the present second embodiment, as shown in FIGS. 3, 4, the surface-hardened layer 61 has a different structure from that in the first embodiment. In the embodiment shown in FIG. 3, the surface-hardened layer 61 is formed by carburizing the surface of the moving core 22. More specifically, the surface of the moving core 22 including the inner circumferential periphery 231 of the through hole 23 is substantially entirely carbonized and thereby increased in hardness so as to form the surface-hardened layer 61. The surface-hardened layer 61 may be formed by nitriding, instead of or in addition to carbonizing. The structure of the injector 1 other than the surface-hardened layer 61 is substantially equivalent to that of the first embodiment. In the embodiment shown in FIG. 4, the surface-hardened layer 61 is a tubular member formed from a material harder than the magnetic material, such as electromagnetic stainless steel, of the moving core 22. The surface-hardened layer 61 is press-fitted into the inner circumferential periphery 231 of the through hole 23 of the moving core 22. The tubular member as the surface-hardened layer 61 is formed from, for example, SUS440C. The structure of the injector 1 other than the surface-hardened layer 61 is substantially equivalent to that of the first embodiment. In the embodiments shown in FIGS. 3, 4, the surface-hardened layer 61 is capable of sufficiently reducing abreaction of the moving core 22, and thereby durability and reliability of the injector 1 can be enhanced. The structure of the injector 1 other than the surface-hardened layer 61 is substantially equivalent to that of the first embodiment.

### Third Embodiment

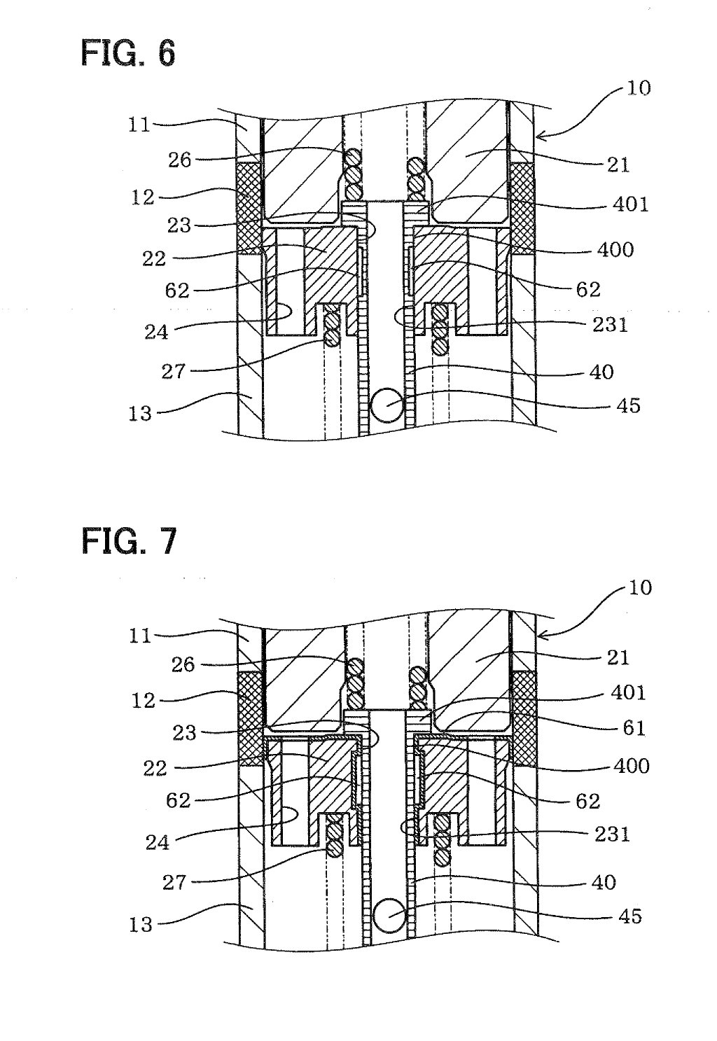

According to the present third embodiment, as shown in FIGS. 5, 6, a fuel accumulator portion 62 is provided to the injector, instead of the surface-hardened layer 61. Specifically, the inner circumferential periphery 231 of the through hole 23 of the moving core 22 and an outer circumferential periphery 400 of the needle 40 therebetween define the fuel accumulator portion 62. At least one of the inner circumferential periphery 231 and the outer circumferential periphery 400 is recessed so as to define the fuel accumulator portion 62. In the embodiment shown in FIG. 5, the inner circumferential periphery 231 of the through hole 23 of the moving core 22 is recessed entirely in the circumferential direction so as to define the fuel accumulator portion 62. In the embodiment shown in FIG. 6, the outer circumferential periphery 400 of the needle 40 has a sliding portion, which is slidable along the inner circumferential periphery 231 of the through hole 23 of the moving core 22, and the sliding portion is recessed entirely in the circumferential direction so as to define the fuel accumulator portion 62. The structure of the injector 1 other than the fuel accumulator portion 62 is substantially equivalent to that of the first embodiment.

In each of the embodiments shown in FIGS. 5, 6, fuel is accumulated in the fuel accumulator portion 62 defined on the sliding portion, and thereby sliding motion of the needle 40 in the through hole 23 of the moving core 22 becomes further smooth. In the present structure, ablation of the moving core 22 can be also reduced. In addition, even when the moving core 22 is abraded to cause ablation powder, the ablation powder can be discharged into the fuel accumulator portion 62, which is provided on the sliding portion. In the present structure, abrasion and seizure of the moving core 22 due to ablation powder remaining between the needle 40 and the moving core 22 can be reduced, and thereby reliability of the injector 1 can be further enhanced. The structure of the injector 1 other than the fuel accumulator portion 62 is substantially equivalent to that of the first embodiment.

The fuel accumulator portion 62 may be provided on both the inner circumferential periphery 231 of the through hole 23 of the moving core 22 and the outer circumferential periphery 400 of the needle 40, as long as the needle 40 is smoothly slidable in the through hole 23 of the moving core 22. For example, the number of the fuel accumulator portion 62, the location of the fuel accumulator portion 62, and the shape of the fuel accumulator portion 62 may be arbitrary changed.

In the present embodiment, instead of the surface-hardened layer 61, the fuel accumulator portion 62 is provided. Alternatively, both the surface-hardened layer 61 and the fuel accumulator portion 62 may be provided. For example, as shown in FIG. 7, the surface-hardened layer 61 according to the first embodiment may be provided to the inner circumferential periphery 231, in addition to the fuel accumulator portion 62 on the inner circumferential periphery 231 of the through hole 23 of the moving core 22. In this case, in addition to the effect produced by the fuel accumulator portion 62, the effect produced by the surface-hardened layer 61 can be further obtained.

### Fourth Embodiment

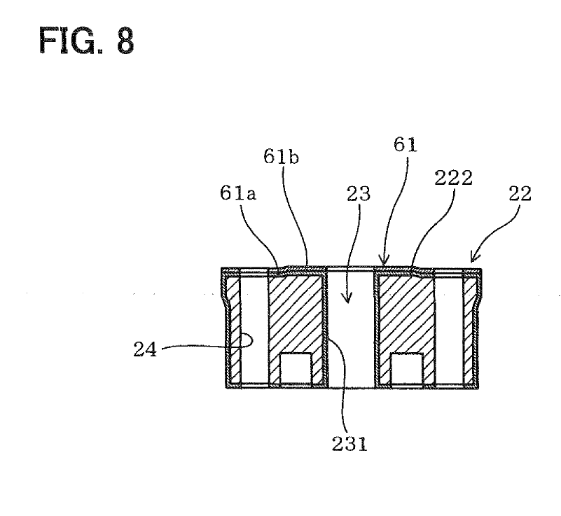

According to the present fourth embodiment, as shown in FIG. 8, the structure of the surface-hardened layer 61 is modified. Specifically, the entire surface of the moving core 22 including the inner circumferential periphery 231 of the through hole 23 is applied with electroless plating to form a surface-hardened layer 61a. The moving core 22 has the rear end surface 222 as a contact surface via which the moving core 22 makes contact with the stator 21. The rear end surface 222 has the surface-hardened layer 61a, which is formed by electroless plating. A surface-hardened layer 61b is further formed by electroplating on the surface-hardened layer 61a.

As follows, formation of the surface-hardened layer 61, which includes the surface-hardened layers 61a and 61b, will be described. First, the entire surface of the moving core 22 including the inner circumferential periphery 231 of the through hole 23 is applied with electroless plating. Subsequently, the rear end surface 222 of the moving core 22 is applied with electroplating. Thus, the surface-hardened layer 61a as an electroless plating film and the surface-hardened layer 61b as an electroplating film can be formed at a desired location. In the present embodiment, the electroless plating film is formed from Ni—P, and the electroplating film is formed from hard chrome, for example, The structure of the injector 1 other than the surface-hardened layer 61 is substantially equivalent to that of the first embodiment.

An operation effect according to the present embodiment will be described. In the present embodiment, the inner circumferential periphery 231 of the through hole 23 of the moving core 22 is provided with the surface-hardened layer 61a, which includes the electroless plating film formed by electroless plating. In the electroless plating, a plated portion need not be supplied with an electric current. Therefore, even when the inner circumferential periphery 231 of the through hole 23 of the moving core 22 is complicated in shape, the plating film can be steadily formed, and thereby the plating film can be enhanced in quality. Further, the rear end surface 222 of the moving core 22 is provided with the surface-hardened layer 61b, which includes the electroplating film. When the moving core 22 is moved by magnetic attractive force, which is caused between the moving core 22 and the stator 21, the moving core 22 collides against the stator 21. Therefore, large impact force is applied to the rear end surface 222 as the contact surface via which the moving core 22 makes contact with the stator 21. According to the present embodiment, the surface-hardened layer 61b is provided to the rear end surface 222 of the moving core 22, and thereby abrasion of the moving core 22 can be reduced. In addition, the surface-hardened layer 61b is the electroplating film and has sufficient hardness. Therefore, abrasion of the moving core 22 can be further reduced. When the electroplating film is formed from hard chrome and significantly high in hardness, the effect produced by the surface-hardened layer 61b can be further enhanced.

In the formation of the surface-hardened layer 61 including the surface-hardened layers 61a and 61b, the entire surface of the moving core 22 including the inner circumferential periphery 231 of the through hole 23 is first applied with electroless plating, and thereafter the rear end surface 222 of the moving core 22 is applied with electroplating. Therefore, manufacturing process such as masking of the moving core 22 can be facilitated. In addition, manufacturing cost can be reduced, and product quality can be significantly enhanced. The structure and operation effect of the injector 1 other than the surface-hardened layer 61 is substantially equivalent to that of the first embodiment. The electroless plating may be compound plating such as Ni—P, Ni—B, Ni—P-Teflon (registered trademark), or the like.

In the above embodiments, the magnetic material of the moving core may be electromagnetic stainless steel, a ferrous material, permendur, or the like. The magnetic material of the stator may be equivalent to the magnetic material of the moving core.

In the above embodiments, the thickness of the film, which is formed from a material harder than the magnetic material of the moving core, is preferably between 1 and 15 micrometers in thickness. When the thickness of the film is less than 1 micrometer, the moving core may cause ablation. On the other hand, when the thickness of the film is greater than 15 micrometers, variation in thickness of the film may become large, and consequently the clearance between the moving core and the valve element may also significantly vary. As a result, performance of the fuel injection valve may not be properly secured.

In the second embodiment, when the surface-hardened layer is formed by fitting the tubular member, which is formed from a material harder than the magnetic material of the moving core, in the inner circumferential periphery of the through hole of the moving core, the surface-hardened layer is capable of reducing abrasion of the moving core. Consequently, durability and reliability of the fuel injection valve can be enhanced. In this case, the cylindrical member may be formed from stainless steel (SUS) such as SUS440C.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

The above structures of the embodiments can be combined as appropriate. Various modifications and alternations may be diversely made to the above embodiments without departing from the spirit of the present invention.

What is claimed is:

1. A fuel injection valve comprising:
a housing substantially in a tubular shape;
a coil located radially outside the housing;
a stator located radially inside the housing, the stator being formed from a magnetic material and substantially in a tubular shape;
a moving core located radially inside the housing and opposed to the stator in an axial direction, the moving core being formed from a magnetic material and substantially in a tubular shape, the moving core being configured to move toward the stator when being drawn by magnetic attractive force caused between the moving core and the stator in response to energization of the coil; and
a valve element movable together with the moving core in the axial direction and configured to open and close a nozzle hole for controlling fuel injection,
wherein the moving core has an inner periphery defining a through hole in which the valve element is slidable in the axial direction, and the inner periphery has a first surface-hardened layer.

2. The fuel injection valve according to claim 1; wherein the first surface-hardened layer includes a film formed from a material harder than the magnetic material of the moving core.

3. The fuel injection valve according to claim 2, wherein the first surface-hardened layer is a plating film formed by electroless plating.

4. The fuel injection valve according to claim 1, wherein the first surface-hardened layer is formed by one of carbonizing and nitriding the inner periphery.

5. The fuel injection valve according to claim 1,
wherein the first surface-hardened layer is formed by fitting a tubular member in the inner periphery, and
the tubular member is formed from a material harder than the magnetic material of the moving core.

6. The fuel injection valve according to claim 1,
wherein the inner periphery of the through hole and an outer periphery of the valve element therebetween define a fuel accumulator portion, and
the fuel accumulator portion is a recess of at least one of the inner periphery and the outer periphery.

7. The fuel injection valve according to claim 6, wherein the fuel accumulator portion is formed on the at least one of the inner periphery and the outer periphery entirely in a circumferential direction.

8. The fuel injection valve according to claim 1,
wherein the moving core has a contact surface via which the stator is configured to make contact with the moving core, and
the contact surface has a second surface-hardened layer.

9. The fuel injection valve according to claim 8, wherein the second surface-hardened layer is a plating film formed by electroplating.

10. The fuel injection valve according to claim 1,
wherein the moving core has an outer sliding surface via which the moving core is slidable on an inner periphery of the housing, and
the outer sliding surface has a third surface-hardened layer.

11. The fuel injection valve according to claim 1,
wherein the moving core has a periphery, which entirely has an inner surface-hardened layer formed by electroless plating, and
the first surface-hardened layer is formed by electroplating on the inner surface-hardened layer.

12. A fuel injection valve comprising:
a housing substantially in a tubular shape;
a coil located radially outside the housing;
a stator located radially inside the housing, the stator being formed from a magnetic material and substantially in a tubular shape;
a moving core located radially inside the housing and opposed to the stator in an axial direction, the moving core being formed from a magnetic material and substantially in a tubular shape, the moving core being configured to move toward the stator when being drawn by magnetic attractive force caused between the moving core and the stator in response to energization of the coil; and
a valve element movable together with the moving core in the axial direction and configured to open and close a nozzle hole for controlling fuel injection,
wherein the moving core has an inner periphery defining a through hole in which the valve element is slidable in the axial direction,
the inner periphery of the through hole and an outer periphery of the valve element therebetween define a fuel accumulator portion, and
the fuel accumulator portion is a recess of at least one of the inner periphery and the outer periphery.

13. The fuel injection valve according to claim 12, wherein the fuel accumulator portion is formed on the at least one of the inner periphery and the outer periphery entirely in a circumferential direction.

14. The fuel injection valve according to claim 12, wherein the inner periphery has a first surface-hardened layer.

15. The fuel injection valve according to claim 14, wherein the first surface-hardened layer includes a film formed from a material harder than the magnetic material of the moving core.

16. The fuel injection valve according to claim 15, wherein the first surface-hardened layer is a plating film formed by electroless plating.

17. The fuel injection valve according to claim 14, wherein the first surface-hardened layer is formed by one of carbonizing and nitriding the inner periphery.

18. The fuel injection valve according to claim 14,
wherein the first surface-hardened layer is formed by fitting a tubular member in the inner periphery, and
the tubular member is formed from a material harder than the magnetic material of the moving core.

19. The fuel injection valve according to claim 14,
wherein the moving core has a contact surface via which the stator is configured to make contact with the moving core, and
the contact surface has a second surface-hardened layer.

20. The fuel injection valve according to claim 19, wherein the second surface-hardened layer is a plating film formed by electroplating.
